(19) United States
(12) Patent Application Publication
(10) Pub. No.: US 2016/0136892 A1
(43) Pub. Date: May 19, 2016

(54) METHOD FOR MANUFACTURING AN AIRCRAFT OR SPACECRAFT COMPONENT COMPRISING A CRACK STOPPER USING ADDITIVE LAYER MANUFACTURING

(71) Applicant: Airbus Operations GmbH, Hamburg (DE)

(72) Inventors: Matthias HEGENBART, Hamburg (DE); Hermann BENTHIEN, Hamburg (DE)

(21) Appl. No.: 14/943,684

(22) Filed: Nov. 17, 2015

(30) Foreign Application Priority Data
Nov. 19, 2014 (DE) 10 2014 116 933.6

(51) Int. Cl. B29C 67/00; B64F 5/00

(52) U.S. Cl. CPC B29C 67/0077; B64F 5/0009; B29K 2105/12

(57) ABSTRACT

This relates to a method for manufacturing an aircraft or spacecraft component comprising a crack stopper using additive layer manufacturing. In a step of the method, a shell-like structural component comprising a first material is provided. In another step, a hole in the shell-like structural component is provided. In yet another step of the method, a second material is applied to a first surface of the shell-like structural component by additive layer manufacturing such that a first elongated protrusion or a circular protrusion on the first surface of the shell-like structural component is generated to form a first crack stopper. This also relates to an aircraft or spacecraft component manufactured using additive layer manufacturing and to the use of an aircraft component as structural component in an aircraft.

### CROSS-REFERENCE TO RELATED APPLICATIONS

This application claims priority to German Patent Application No. DE 10 2014 116 933.6 filed Nov. 19, 2014, which is incorporated herein by reference in its entirety.

### TECHNICAL FIELD

The embodiments described herein relate to a manufacturing process for an aircraft or spacecraft component. In particular, the embodiments relate to a method for manufacturing an aircraft or spacecraft component comprising a crack stopper using additive layer manufacturing, an aircraft or spacecraft component manufactured by using additive layer manufacturing and the use of such an aircraft component as structural component in an aircraft.

### BACKGROUND

In addition, other objects, desirable features and characteristics will become apparent from the subsequent summary and detailed description, and the appended claims, taken in conjunction with the accompanying drawings and this background.

In many cases, manufacturing aircraft components or spacecraft components require the application of subtractive processes, like for example milling, cutting, machining, drilling, etc. These subtractive processes may rely on the principle that a certain part of material is removed from the component in order to change the contours or the shape of the component which may be assembled in a later step. Such subtractive processes may involve high material usage, especially if the geometry of the aircraft or spacecraft component which has to be manufactured is complex. However, subtractive processes may be limited in their application since material is removed from the component. For example, dents or scratches on the surfaces of the aircraft or spacecraft component may only be repaired by removing a distinct amount of material from the surface.

U.S. Pat. No. 6,712,315 B2 describes a metallic structural component for an aircraft with resistance to crack propagation. The metallic structural component includes stiffening profile members with a first and second part which are connected so as to form an internal boundary surface. The internal boundary surface is adapted to resist further crack propagation of a formed crack.

U.S. Pat. No. 6,595,467 B2 describes an aircraft fuselage shell component with crack propagation resistance. A stiffening member is reinforced with a web doubler plate or a tension band made of different materials.

### SUMMARY

According to a first aspect, a method for manufacturing an aircraft or spacecraft component comprising a crack stopper using additive layer manufacturing (ALM) is provided. In a step of the method, a shell-like structural component comprising a first material is provided. In another step of the method, a hole in the shell-like structural component is provided. In another step, a second material is applied to a first surface of the shell-like structural component by additive layer manufacturing such that a first elongated protrusion or circular protrusion on the first surface of the shell-like structural component is generated in order to form a first crack stopper.

Using additive layer manufacturing in order to form a crack stopper which is integrated in an aircraft or spacecraft component, provides the opportunity to induce internal stresses within the aircraft or spacecraft component such that crack generation within the aircraft or spacecraft component is decelerated or even inhibited. Additionally, material may be saved since subtractive processes like milling, cutting and machining may be avoided. Furthermore, it is possible to apply material to a surface of a component such that in regions where the material has been applied to the surface, internal stresses may be precisely integrated into the component. In other words, the internal stresses within aircraft or spacecraft components may be influenced by using additive layer manufacturing wherein the internal stresses may be dependent on the arrangement of the applied material on the surface of the respective component. The generation of internal stresses within the components may also be dependent on the material characteristics, if for example different materials are used during the additive layer manufacturing process.

The aircraft or spacecraft component may be a primary structure of an aircraft or spacecraft. For example, the aircraft or spacecraft component is a part of an outer skin of the aircraft or spacecraft. Therefore, the aircraft or spacecraft component may be a shell-like structure or a plate. But the aircraft or spacecraft component may also be a part of a framework of the aircraft or spacecraft, such as a stiffening unit of a fuselage of the aircraft or spacecraft. For example, the aircraft or spacecraft component may be a stringer, a rib or a floor plate of the aircraft or spacecraft. However, the aircraft or spacecraft component may comprise a shell-like structural component. The shell-like structural component may be made of a first material which for instance is a metallic or non-metallic material. The shell-like structural component may also be a composite material, like for example a carbon fiber reinforced material. Furthermore, a hole is provided within the shell-like structural component. The hole may be a through-hole which for instance is drilled into the shell-like structural component. The hole may be drilled hole which is arranged perpendicular to the first surface of the shell-like structural component. Since the shell-like structural component as well as the protrusions on the first surface of the shell-like structural component may be manufactured by additive layer manufacturing, the hole may also be provided by a three-dimensional printing process in which different material layers are subsequently applied such that the shell-like structural component is established. In other words, using additive layer manufacturing provides the possibility to generate complex geometries and therefore also shell-like structural components comprising holes and/or protrusions. The shell-like structural component may be a part of an outer skin of the aircraft or spacecraft. Therefore, the shell-like structural component may comprise a curved surface.

The first elongated or circular protrusion may be located near or in a region where the hole is located with respect to the shell-like structural component. For example, the first elongated protrusion may be in direct contact to the hole such that the first elongated protrusion may continue tangentially at a lateral surface of the hole. Since the second material of the protrusion is different to the first material of the shell-like structural component, internal stresses may be generated within the shell-like structural component after the protrusion has been applied to the shell-like structural component. For example, the internal stresses may occur when finishing the additive layer manufacturing process or when cooling the aircraft or spacecraft component which comprises both shell-like structural component and protrusion to environmental or other temperature conditions. During the application of the second material and therefore the protrusion to the shell-like structural component, the second material may be a powder which is supplied to the shell-like structural component by a powder supply unit. This powder may be a metallic or non-metallic powder which is when applied to the shell-like structural component heated and/or melted. The procedure of applying the second material to the shell-like structural component may also be called printing process. By melting the second material and a part or a region of the shell-like structural component which comprises the first material, a connection or continuity between both the first material of the shell-like structural component and the second material of the protrusion may be achieved. For example, the second material is mixed with and/or firmly bonded to a certain region of the shell-like structural component such that the protrusion forms an integrated part of the shell-like structural component. For heating or melting the second material and/or the first material in the region of the shell-like structural component where the protrusion is to be located, different methods may be used, such as selective laser melting (SLM). The heating of the second material of the protrusion and the first material of the shell-like structural component may be achieved by a laser beam. The heating of the second material by the laser beam may be conducted during the second material is applied to the first surface of the shell-like structural component. In this manner, it is ensured that both the second material which later provides the protrusion and the first material which is comprised by the shell-like structural component may be melted in the region where the protrusion is to be placed on the first surface of the shell-like structural component. Thus, the protrusion may be firmly bonded to the surface of the shell-like structural component such that a continuity between the protrusion, e.g. the second material, and the shell-like structural component, e.g. the first material, is provided.

In another step, the melted second material and the melted first material are cooled down, for example to environmental conditions such that the melted part of the shell-like structural component as well as the second material may be solidified. After solidification, an internal stress within the shell-like structural component is generated. The internal stress may rely on the principle that different temperatures during the additive layer manufacturing process are used or on the fact that the first material is different to the second material, e.g. the first material has another coefficient of thermal expansion than the second material. The internal stresses being generated after solidification may be limited to the regions where the second material and hence the protrusion has been applied to the shell-like structural component. The internal stresses provide an enhanced mechanical robustness or resistance of the regions within the shell-like structural component to which the second material has been applied. For example, regions of the shell-like structural component which are near or around the hole may be enhanced in their mechanical robustness or resistance. It may be possible that the first and the second material are identical. Using identical materials for the first material and the second material may also result in a generation of internal stresses within the shell- like structural component, for example by applying the second material to certain locations on the surface of the shell-like structural component which comprises the first material. The generated internal stresses may then be dependent on the shape or arrangement of the protrusions, e.g. the second material, on the surface of the shell-like structural component.

The shell-like structural component may be a plate with a curved surface or an even plate with no curvature. However, the shell-like structural component may be a three-dimensional solid which comprises several materials. The shell-like structural component may be manufactured from metallic or non-metallic materials. The shell-like structural component may be a part of a large structural component of the aircraft or spacecraft. For example, the shell-like structural component is a sidewall panel or a part of the outer skin of the aircraft or spacecraft that comprises a curved or even surface.

Generally, the shell-like structural component is a three-dimensional structural element with a small thickness when compared to other dimensions of the shell-like structural component.

The protrusion may have an elongated shape or a circular shape. For example, the elongated protrusion may have a cuboidal shape and the circular protrusion may have an annular or ring-like shape. However, the elongated protrusion may be arranged tangentially to the lateral surface of the hole of the shell-like structural component.

According to an embodiment, the second material is applied to the first material of the shell-like structural component by additive layer manufacturing such that a second elongated protrusion on the first surface of the shell-like structural component is generated to form a second crack stopper.

Thus, a more effective crack stopping effect may be achieved by appropriately arranging the first elongated protrusion and the second elongated protrusion on the shell-like structural component. The first elongated protrusion and the second elongated protrusion may be applied to the first surface of the shell-like structural component simultaneously or consecutively. Both the first elongated protrusion and the second elongated protrusion may be directly connected to or placed directly at the hole such that cracks which are initiated at the hole and therefore start at the hole can be effectively stopped which results in a deceleration or inhibition of the crack propagation.

According to another embodiment, the second elongated protrusion is arranged substantially parallel to the first elongated protrusion on the first surface of the shell-like structural component such that the hole is arranged between the first elongated protrusion and the second elongated protrusion.

The elongated protrusions may be arranged such that a longitudinal direction of the elongated protrusions is substantially parallel to a main loading direction of the shell-like structural component and/or the hole. In this manner, crack propagation may be effectively stopped. The first elongated protrusion and the second elongated protrusion may be tangentially arranged at the hole, e.g. at a lateral surface of the hole, but there may also be a distance between the protrusions and the hole in a lateral direction of the shell-like structural component. Therein, the lateral direction may be parallel or tangential to the first surface of the shell-like structural component. The lateral direction may also be substantially perpendicular to a longitudinal direction of the first and second elongated protrusions. Therefore, the hole may be arranged between the first elongated protrusion and the second elongated protrusion with respect to the lateral direction.

According to yet another embodiment, the hole is encircled by the circular protrusion such that a center of the hole is congruent to a center of the circular protrusion.

Providing a circular protrusion, decelerates or even stops crack propagation starting from the hole in every direction around the hole within the shell-like structural component. Since the circular protrusion may be ring-like shaped, an encircling of the hole can be achieved. It should be mentioned that the circular protrusion encircles the hole on the first surface of the shell-like structural component.

The center of the hole may be located on a symmetry axis of the hole. The circular protrusion can be imagined as a local thickening of the shell-like structural component in a region of or around the hole.

According to another embodiment, a length of the first or second elongated protrusion is at least three times greater than a width of the first or second elongated protrusion.

For example, the length of the first elongated protrusion and the second elongated protrusion is greater than a diameter of the hole. Therein, the length is measured along the longitudinal direction of the elongated protrusions. The elongated protrusions may at least be twice as long as the diameter of the hole. Furthermore, the elongated protrusions may vary in their height in the longitudinal direction. The height may be measured in a perpendicular direction to the longitudinal direction and the lateral direction of the elongated protrusions. Hence, the height may be measured in a perpendicular direction of the first surface of the shell-like structural component. Varying the height to which the elongated protrusions protrude on the first surface of the shell-like structural component provides the opportunity to induce different internal stresses at different locations of the elongated protrusions. In this manner, the crack stopping characteristics at different locations of the shell-like structural component can be influenced.

According to another embodiment, a transition region between the first surface of the shell-like structural component and the first elongated or circular protrusion is represented by a Baud curve.

In other words, the transition region is formed for providing a changeover from the first surface of the shell-like structural component to the first elongated or circular protrusion. Therefore, the transition region may be arranged at lateral ends of the protrusions with respect to a top view onto the protrusion and/or the shell-like structural component. A Baud curve is a fillet which is represented by a contour established by an ideal frictionless fluid flowing under gravity from a circular opening in the bottom of a tank.

The first elongated protrusion and/or the second elongated protrusion and/or the circular protrusion may be optimized in their shape. For example, the elongated protrusions may comprise radii at their longitudinal ends. Therein, the radii at the longitudinal ends of the elongated protrusions may provide transition areas between the first surface of the shell-like structural component and the protrusions such that a smooth changeover from the first surface to the protrusion may be provided. In this manner, notch stresses or stress peaks can be avoided. Therefore, a longitudinal end of an elongated protrusion may comprise a plurality of radii such that the transition between the protrusion and the first surface follows a Baud curve. Hence, the Baud fillet may be provided. This aspect will be further described in the detailed description of the drawings.

According to another embodiment, the second material used for generating the first elongated or circular protrusion is a fiber reinforced material.

In this manner, integrated fibers may act as a crack stopper. Therefore, the fibers may be integrated in a matrix structure which is comprised by the elongated protrusions. The fibers within the elongated protrusions may be arranged substantially parallel and/or substantially perpendicular to the longitudinal direction of the elongated protrusions. The fibers as well as the matrix structure may be printed by additive layer manufacturing. In other words, the method provides the possibility to apply a material in a fibrous form by using additive layer manufacturing. The fibers may be applied in the same manner as the matrix structure in which the fibers are embedded.

Using fiber reinforced material for the elongated protrusions effectively avoids an opening of an initiated crack or crack propagation in general. Moreover, the printed or applied fibers may have an individual cross-sectional area. This means that using additive layer manufacturing, the diameter of the fibers may be adapted to the mechanical requirements of the crack stopping elements, e.g. the elongated or circular protrusions. In case a circular protrusion is applied to the first surface of the shell-like structural component, the fibers may be applied in a circumferential direction such that the fibers encircle the hole. However, the fibers may be applied or printed such that they are embedded in the matrix structure wherein the matrix structure together with the fibers provide the protrusions.

According to yet another embodiment, the second material is applied to a second surface of the shell-like structural component such that a third elongated or second circular protrusion on the surface of the shell-like structural component is generated. Therein, the first surface and the second surface are oppositely arranged with respect to the shell-like structural component.

In other words, both sides of the shell-like structural component which for instance is a plate or a curved body with a small thickness may be provided with crack stoppers. Hence, a thickening of the shell-like structural component in the regions where the protrusions are applied to the shell-like structural component occurs. By applying the second material to both surfaces of the shell-like structural component, a more efficient internal stress generation within the shell-like structural component can be achieved resulting in an improved crack stopping effect. For example, the first elongated protrusion and the second elongated protrusion may be applied to the first surface such that they are arranged parallel to each other wherein the hole is arranged between the first elongated and the second elongated protrusion. Analogously, the third elongated protrusion and a fourth elongated protrusion may be applied to the second surface such that they are arranged parallel to each other and such that the hole is arranged between the third and the fourth elongated protrusion. The first, the second, the third and the fourth elongated protrusion may be arranged parallel to each other.

When applying a circular protrusion on the first surface of the shell-like structural component, it is also possible to apply elongated protrusions on the second surface of the same shell-like structural component and vice versa.

According to another aspect, an aircraft or spacecraft component manufactured using additive layer manufacturing is provided. The aircraft or spacecraft component comprises a shell-like structural component with a hole which for instance may be a drilled hole or which hole may be generated by additive layer manufacturing. The aircraft or spacecraft component further comprises a first elongated or a circular protrusion which extends on a first surface of the shell-like structural component such that the first elongated or the circular protrusion together with the shell-like structural component provide a crack stopper. The first elongated protrusion or the circular protrusion may be firmly bonded to the shell-like structural component after the first elongated or circular protrusion have been applied to the first surface of the shell-like structural component during the additive layer manufacturing process. The shell-like structural component comprises a first material and the first elongated or circular protrusion comprises a second material. The bonding between the shell-like structural component and the elongated or circular protrusion may be achieved by heating or melting at least a part of the shell-like structural component and therefore the first material as well as the second material during the additive layer manufacturing process. The heating or melting may be achieved by a laser beam.

According to another aspect, the use of an aircraft or spacecraft component as a structural component in an aircraft is provided. The aircraft or spacecraft component may be manufactured by the described method for manufacturing an aircraft or spacecraft component comprising a crack stopper using additive layer manufacturing.

### BRIEF DESCRIPTION OF THE DRAWINGS

The various embodiments will hereinafter be described in conjunction with the following drawing figures, wherein like numerals denote like elements, and:

FIG. 1A shows a crack stopping element on a shell-like structural component comprising two elongated protrusions according to an embodiment.

FIG. 1B shows a crack stopping element on a shell-like structural component comprising two elongated protrusions according to another embodiment.

FIG. 1C shows a crack stopping element on a shell-like structural component comprising two elongated protrusions according to another embodiment.

FIG. 2 shows a cross-sectional view of elongated protrusions on two different sides of a shell-like structural component according to an embodiment.

FIG. 3A shows a crack stopping element on a shell-like structural component comprising a circular protrusion according to an embodiment.

FIG. 3B shows a crack stopping element on a shell-like structural component comprising a circular protrusion according to another embodiment.

FIG. 3C shows a crack stopping element on a shell-like structural component comprising a circular protrusion according to another embodiment.

FIG. 4A shows a crack propagation within a fiber reinforced material of a protrusion according to an embodiment.

FIG. 4B shows a crack within a fiber reinforced material of a protrusion according to an embodiment.

FIG. 5 shows a flow diagram of a method for manufacturing an aircraft or spacecraft component comprising a crack stopper using additive layer manufacturing according to an embodiment.

### DETAILED DESCRIPTION

The following detailed description is merely exemplary in nature and is not intended to limit the disclosed embodiments or the application and uses thereof Furthermore, there is no intention to be bound by any theory presented in the preceding background

### DETAILED DESCRIPTION

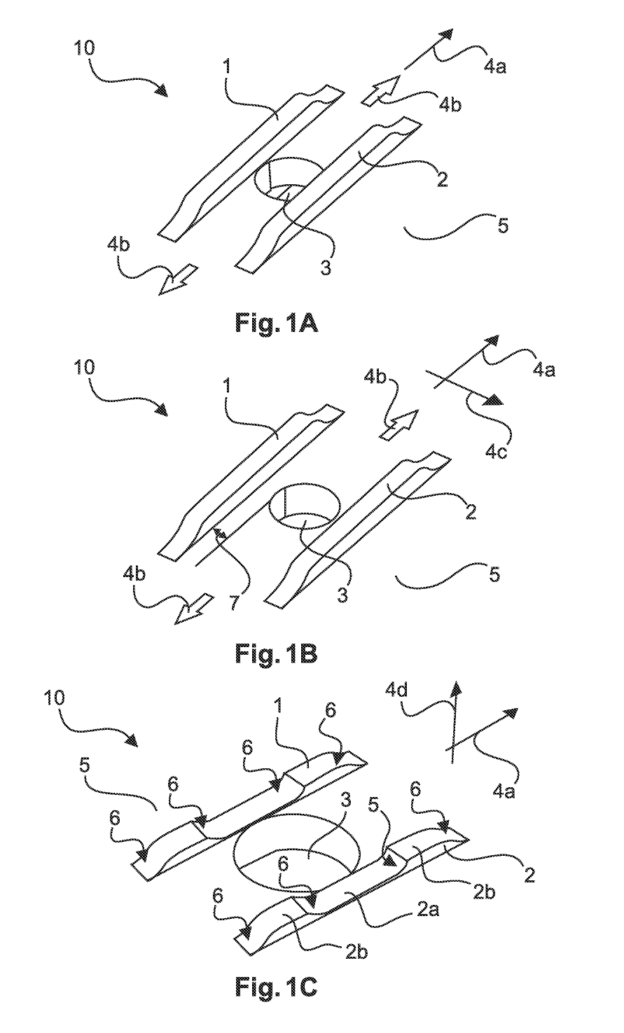

FIG. 1A shows a crack stopping element 10 fabricated by a method according to an exemplary embodiment, comprising two crack stoppers wherein the two crack stoppers are represented by a first elongated protrusion 1 and a second elongated protrusion 2 on a first surface of a shell-like structural component 5. In general, a crack stopping element 10 may comprise a plurality of crack stoppers and/or different arrangements of crack stoppers. The first elongated protrusion 1 and the second elongated protrusion 2 may be arranged substantially parallel to a longitudinal direction 4a of the elongated protrusions 1, 2. The elongated protrusions 1, 2 are arranged parallel to each other such that a hole 3 is arranged between the parallel elongated protrusions 1, 2. The loading direction is indicated by arrows 4b, which loading direction indicates the direction into which a force acts on the hole 3 when the shell-like structural component 5 is assembled to other components by the hole 3. The crack initiation which may occur at the hole 3 can be effectively avoided by applying the elongated protrusions 1, 2 to the first surface of the shell-like structural component 5 and thus inducing internal stresses within the shell-like structural component 5. The elongated protrusions 1, 2 may be arranged directly at the hole such that both first elongated protrusion 1 and second elongated protrusion 2 are arranged tangentially with respect to the lateral surface of the hole 3. The hole 3, which may be a through-hole extending through the shell-like structural component 5, may be adapted for receiving a rivet, a bolt or a screw for assembling or attaching another component to the shell-like structural component 5 in order to form an aircraft or spacecraft component.

FIG. 1B shows a crack stopping element 10 fabricated by a method according to an exemplary embodiment, comprising two crack stoppers which are represented by a first elongated protrusion 1 and a second elongated protrusion 2. Again, the arrows 4b indicate the loading direction of the shell-like structural component 5 in an assembled state of the shell-like structural component 5 in which the shell-like structural component 5 is assembled or attached to another component in order to form an aircraft or spacecraft component. In contrast to the crack stopping element shown in FIG. 1A, the crack stopping element shown in FIG. 1B comprises two elongated protrusions 1, 2 which are not directly located at the hole 3. For example, there is a distance 7 between the lateral surface of the hole 3 and the elongated protrusions 1, 2. The elongated protrusions 1, 2 are arranged parallel to each other and substantially parallel to the longitudinal direction 4a. The distance 7 between the lateral surface of the hole 3 and the first elongated protrusion 1 may be measured in a lateral direction 4c. The distance 7 between the lateral surface of the hole 3 and the second elongated protrusion 2 may be the same as between the lateral surface of the hole 3 and the first elongated protrusion 1.

FIG. 1C shows another example of a crack stopping element 10 fabricated by a method according to an exemplary embodiment, comprising two elongated protrusions 2. Therein, both the first elongated protrusion 1 and the second elongated protrusion 2 may vary in their height. In other words, the elongated protrusions may have a different height at different locations with respect to the longitudinal direction 4a. In this manner, the internal stresses generated within the shell-like structural component 5 may be different at different locations at the elongated protrusions 1, 2 with respect to the longitudinal direction 4a. For example, the second elongated protrusion 2 may have two different heights with respect to a vertical direction 4d which is substantially perpendicular to the longitudinal direction 4a and/or the lateral direction 4c. The vertical direction 4d may be parallel to the lateral surface of the hole 3. The height of the protrusions 1, 2 is measured with respect to the vertical direction 4d. The second elongated protrusion 2 may have a first height 2a at a location near the hole. Furthermore, the second elongated protrusion 2 may have a second height 2b at two different areas of the elongated protrusion 2 which are connected to the area with the first height 2a by transition regions 6. The area with the first height 2a may be lower than the areas with the second height 2b. Moreover, the area with the first height 2a may be arranged between the areas with the second height 2b with respect to the longitudinal direction 4a. The transition regions 6 may be defined or represented by radii.

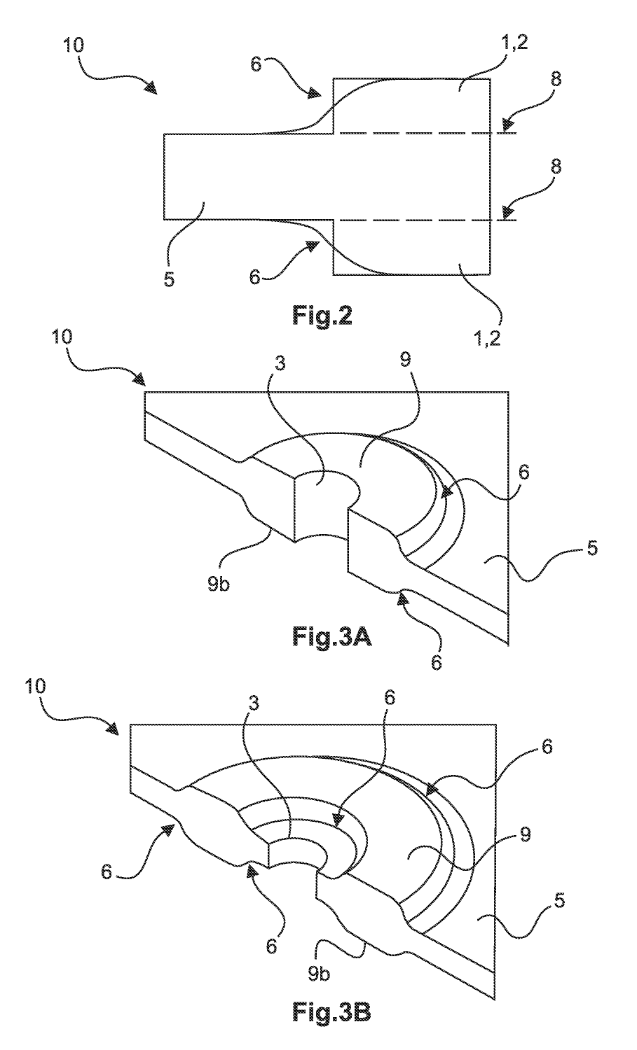

FIG. 2 shows a cross-sectional view of a shell-like structural component 5 fabricated by a method according to an exemplary embodiment, with elongated protrusions 1, 2 on both sides of the shell-like structural component 5. For example, one protrusion is arranged on the first surface of the shell-like structural component 5 and another elongated protrusion 1, 2 is arranged on the second surface of the shell-like structural component 5. The dashed lines 8 indicate the boundaries, e.g. the first and second surface of the shell-like structural component 5, to which the elongated protrusions 1, 2 are applied. The transition region 6 between the surfaces of shell-like structural component 5 and the elongated protrusions 1, 2 may be represented or defined by a Baud curve. In FIG. 2, the Baud curve is indicated by a curved line. This Baud curve may itself be defined by the plurality of radii. In this manner, notch stresses or stress peaks can be avoided since no edges or corners between the shell-like structural component 5 and the elongated protrusions 1, 2 occur. The second material may be applied to the surface of the shell-like structural component such that the Baud curve and therefore the required radii may be provided. It should be mentioned that the distance between the dashed lines in FIG. 2 represents the thickness of the shell-like structural component 5. In addition to the curved line, e. g. the Baud curve, FIG. 2 also shows a transition region 6 with sharp edges. Therein, a step forms the transition between the surfaces of the shell-like structural component and the protrusions. Such a stepped transition region 6 may be an alternative to the transition region 6 comprising the Baud curve. However, it may be possible to provide a stepped transition and a curved transition between the surfaces of the shell-like structural component and the protrusions at different locations. Thus, using additive layer manufacturing, provides the manufacturing of protrusions with both a curved and a stepped shape on the surfaces of the shell-like structural component.

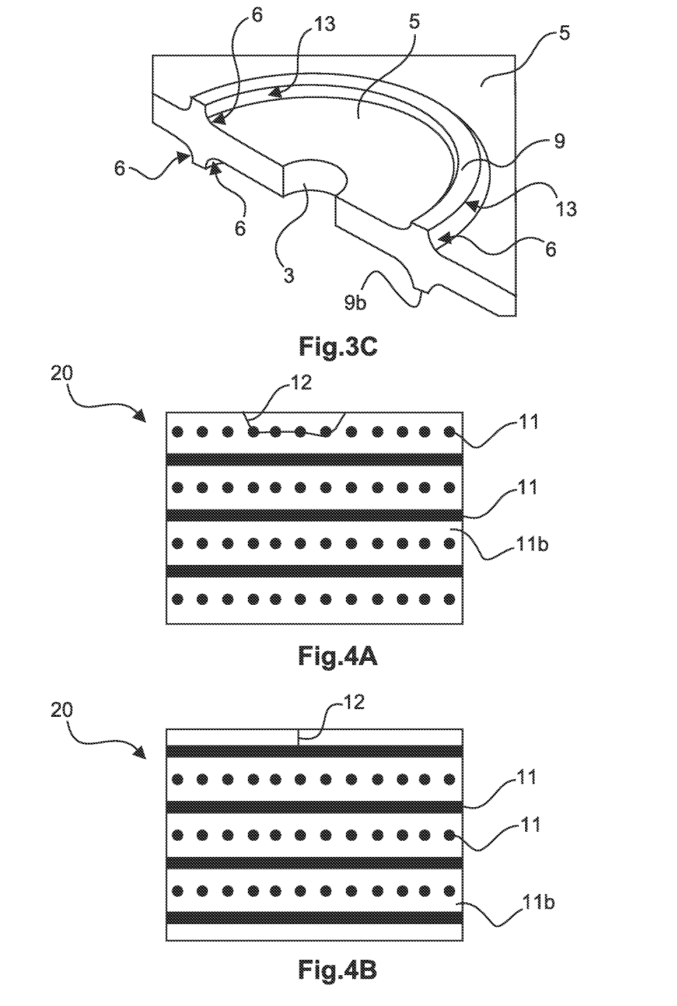

FIG. 3A shows a crack stopping element 10 fabricated by a method according to an exemplary embodiment, with a circular protrusion 9 on the first surface of the shell-like structural component 5. The circular protrusion 9 is formed around the hole 3 such that the circular protrusion 9 encircles the hole 3 which for instance is a drilling hole or a hole which is generated by the additive layer manufacturing process of the shell-like structural component 5 and the circular protrusion 9. The circular protrusion 9 may be arranged on the surface of the shell-like structural component 5 such that the thickening of the shell-like structural component 5 is achieved directly at the hole 3. Furthermore, a transition region 6 may be provided between the first surface of the shell-like structural component 5 and the circular protrusion 9. The transition region 6 may be represented by a Baud curve. In other words, different radii provide the transition region 6 at the changeover from the first surface of the shell-like structural component 5 to the circular protrusion 9. FIG. 3A shows a cross-sectional view of the shell-like structural component 5 and the circular protrusion 9 such that the cross-section continues through the center of the hole 3 or the center of the circular protrusion 9. Furthermore, a second circular protrusion 9b is arranged on the second surface of the shell-like structural component 5. The second circular protrusion 9b may be symmetrically arranged to the first circular protrusion 9 with respect to the shell-like structural component 5. In this manner, the effective thickening of the shell-like structural component 5 in the region around or near the hole 3 may be increased.

FIG. 3B shows a crack stopping element 10 fabricated by a method according to an exemplary embodiment. In particular, FIG. 3B also shows a cross-sectional view of the shell-like structural component 5 comprising the first circular protrusion 9 and the second circular protrusion 9b. The cross-sectional view continues through the center of the hole 3. The circular protrusion 9, 9b is arranged on the first surface and the second surface of the shell-like structural component 5 respectively such that the thickening of the shell-like structural component 5 is not directly established at the hole 3. This means that the thickening of the shell-like structural component 5 starts at a certain distance from the hole 3 such that a thickening of the shell-like structural component 5 has a greater distance to the hole 3 than the thickening of the shell-like structural component 5 shown in FIG. 3A. Furthermore, a transition region 6 at the changeover between the shell-like structural component 5 and the circular protrusion 9 is shown. This transition region 6 may be described by a Baud curve. In FIG. 3B, the circular protrusion 9 is arranged such that two transition regions 6 define the transition between the first surface of the shell-like structural component 5 and the circular protrusion 9. The first transition region 6 is arranged at an inner radius of the circular protrusion 9 with respect to the center of the hole 3 and the second transition region 6 is arranged at an outer radius of the circular protrusion 9 with respect to the center of the hole 3. The second circular protrusion 9b may be arranged on the other side of the shell-like structural component 5, e.g. on the second surface of the shell-like structural component 5. This second circular protrusion 9b may be symmetrically arranged to the first circular protrusion 9 with respect to the first surface of the shell-like structural component 5. The transition region 6 between the second surface of the shell-like structural component 5 and the second circular protrusion 9b may be formed or arranged in the same manner as for the first protrusion 9 on the first surface of the shell-like structural component 5, e.g. by a Baud curve.

FIG. 3C shows a crack stopping element 10 fabricated by a method according to an exemplary embodiment, comprising a first circular protrusion 9 and a second circular protrusion 9b. The distance between the circular protrusions and the center of the hole 3 may be greater than in the examples shown in FIG. 3A and FIG. 3B. Hence, the first and second surface areas of the shell-like structural component 5 between the circular protrusions and the hole 3 may be greater than those shown in FIG. 3A and FIG. 3B. The transition region 6 may be arranged between the first and second surface of the shell-like structural component 5 and the respective circular protrusions 9, 9b. In contrast to FIGS. 3A and 3B, the circular protrusions 9, 9b comprise sharp edges at their maximum height above the first and second surface of the shell-like structural component 5. However, a smooth transition region 6, e. g. changeover between the first and second surfaces of the shell-like structural component 5 and sidewalls 13 of the circular protrusions 9 and 9b may be provided. The transition region 6 may be described by a Baud curve.

FIG. 4A shows a cross-sectional view of a crack stopper fabricated by a method according to an exemplary embodiment, comprising a fiber reinforced material 20. Hence, the protrusion may comprise the fiber reinforced material 20. The fibers 11 may be oriented into different directions within different layers of the protrusion such that a three-dimensional cross-linked fiber network is generated. In different layers of the protrusion, the fibers 11 may be oriented perpendicularly to each other. For example, in a first layer of the protrusion in which the fibers 11 are arranged in juxtaposition, the orientation of the fibers 11 is different to the orientation of the fibers 11 in a second layer in which the fibers 11 are also arranged in juxtaposition. For example, the fibers 11 of the first layer are arranged perpendicular to the fibers 11 of the second layer. The fibers may be applied by additive layer manufacturing. In other words, the fibers 11 may be printed during the additive layer manufacturing process such that the fibers 11 are embedded in a matrix 11b. FIG. 4A also shows a crack 12 on a surface of the protrusion. Crack 12 continues from the surface of the protrusion until the fibers 11 are reached and then the crack 12 continues back to the surface of the protrusion. Thus, the fibers 11 effectively avoid that the crack 12 further opens beyond the first layer of the fibers such that the crack propagation through the whole protrusion can be avoided. Crack propagation within the protrusion can be effectively avoided since internal stresses are generated during the additive layer manufacturing process. This is achieved when applying different materials for the fibers 11 and for the matrix 11b. The different materials induce internal stresses for example during the cooling process after the additive layer manufacturing. This may be due to different coefficients of thermal expansion of the fibers 11 and the matrix 11b.

FIG. 4B shows another cross-sectional view of a crack stopper fabricated by a method according to an exemplary embodiment , comprising a fiber reinforced material 20, e.g. a protrusion, wherein the protrusion comprises different layers of fibers 11 which are embedded in a matrix 11b. Furthermore, a crack 12 on a surface of the protrusion is shown. It is indicated that the crack 12 does not extend beyond the first layer of fibers 11 since internal stresses generated by the arrangement of the fibers 11 within the matrix 11b effectively inhibit a crack propagation through the protrusion.

In general, the integrated or printed fibers may generate internal pressure or tensile stresses such that an improvement of fatigue and damage tolerance can be achieved. Introduced stresses by the fibers may be due to the fact that the fibers and the matrix have a different Young's modulus.

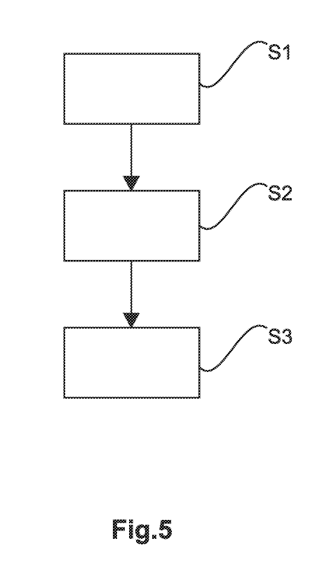

FIG. 5 shows a flow diagram of a method for manufacturing an aircraft or spacecraft component comprising a crack stopper using additive layer manufacturing. In a step S1 of the method, a shell-like structural component 5 comprising a first material is provided. In another step S2 of the method, a hole 3 in the shell-like structural component 5 is provided. In yet another step S4, a second material is applied to a first surface of the shell-like structural component 5 by additive layer manufacturing such that a first elongated protrusion 1 or a circular protrusion 9 on the first surface of the shell-like structural component 5 is generated to form a first crack stopper.

It should be mentioned that different steps of the method may be conducted simultaneously. Furthermore, the sequence of the steps may vary.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A method for manufacturing an aircraft or spacecraft component comprising a crack stopper using additive layer manufacturing, the method comprising:
providing a shell-like structural component comprising a first material;
providing a hole in the shell-like structural component; and
applying a second material to a first surface of the shell-like structural component by additive layer manufacturing such that a first elongated protrusion or a circular protrusion on the first surface of the shell-like structural component is generated to form a first crack stopper.

2. The method according to claim 1, further comprising:
applying the second material to the first surface of the shell-like structural component by additive layer manufacturing such that a second elongated protrusion on the first surface of the shell-like structural component is generated to form a second crack stopper.

3. The method according to claim 2, wherein the second elongated protrusion is arranged substantially parallel to the first elongated protrusion on the first surface of the shell-like structural component such that the hole is arranged between the first elongated protrusion and the second elongated protrusion.

4. The method according to claim 1, wherein the hole is encircled by the circular protrusion such that a center of the hole is congruent to a center of the circular protrusion.

5. The method according to claim 1, wherein a length of the first or second elongated protrusion is at least three times greater than a width of the first or second elongated protrusion.

6. The method according to claim 1, wherein a transition region between the first surface of the shell-like structural component and the first elongated protrusion or circular protrusion is represented by a Baud curve.

7. The method according to claim 1, wherein the second material used for generating the first elongated protrusion or circular protrusion is a fiber reinforced material.

8. The method according to claim 1, further comprising the step of:
applying the second material to a second surface of the shell-like structural component such that a third elongated or a second circular protrusion on the second surface of the shell-like structural component is generated wherein the first surface and the second surface are oppositely arranged with respect to the shell-like structural component.

9. An Aircraft or spacecraft component manufactured using additive layer manufacturing, comprising:
a shell-like structural component with a hole;
wherein a first elongated protrusion or a circular protrusion extends on a first surface of the shell-like structural component such that the first elongated protrusion or the circular protrusion together with the shell-like structural component provide a crack stopper; and wherein the shell-like structural component comprises a first material and the first elongated protrusion or a circular protrusion comprises a second material.

10. (canceled)

11. A method for manufacturing an aircraft or spacecraft component comprising a crack stopper using additive layer manufacturing, the method comprising:
providing a shell-like structural component comprising a first material;
providing a hole in the shell-like structural component; and
applying a second material to a first surface of the shell-like structural component by additive layer manufacturing such that a first elongated protrusion or a circular protrusion on the first surface of the shell-like structural component is generated to form a first crack stopper;
applying the second material to the first surface of the shell-like structural component by additive layer manufacturing such that a second elongated protrusion on the first surface of the shell-like structural component is generated to form a second crack stopper,
wherein the second elongated protrusion is arranged substantially parallel to the first elongated protrusion on the first surface of the shell-like structural component such that the hole is arranged between the first elongated protrusion and the second elongated protrusion, and
wherein the hole is encircled by the circular protrusion such that a center of the hole is congruent to a center of the circular protrusion.

12. The method according to claim 11, wherein a length of the first or second elongated protrusion is at least three times greater than a width of the first or second elongated protrusion.

13. The method according to claim 12, wherein a transition region between the first surface of the shell-like structural component and the first elongated protrusion or circular protrusion is represented by a Baud curve.

14. The method according to claim 12, wherein the second material used for generating the first elongated protrusion or circular protrusion is a fiber reinforced material.

15. The method according to claim 12, further comprising the step of:
applying the second material to a second surface of the shell-like structural component such that a third elongated or a second circular protrusion on the second surface of the shell-like structural component is generated wherein the first surface and the second surface are oppositely arranged with respect to the shell-like structural component.
